(19) United States
(12) Patent Application Publication
(10) Pub. No.: US 2013/0325561 A1
(43) Pub. Date: Dec. 5, 2013

(54) METHODS AND SYSTEMS FOR RATING CREATIVE PRODUCERS

(71) Applicant: POPTENT, INC., San Clemente, CA (US)

(72) Inventors: Timothy Dennis Breslin, Philadelphia, PA (US); Christopher Taylor Vasquez, Nazareth, PA (US)

(73) Assignee: POPTENT, INC., San Clemente, CA (US)

(21) Appl. No.: 13/903,452

(22) Filed: May 28, 2013

Related U.S. Application Data
(60) Provisional application No. 61/653,228, filed on May 30, 2012.

(51) Int. Cl. G06Q 10/06

(52) U.S. Cl. CPC G06Q 10/0639
USPC 705/7.38

(57) ABSTRACT

Methods and systems for determining and using a multi-dimensional rating are disclosed. A plurality of interactions between a plurality of users and an interface may be identified. Active feedback that has been received from at least one of the plurality of users based upon the plurality of interactions may be determined. Passive feedback from at least one of the plurality of users may be identified. The active feedback and the passive feedback may be stored in a memory. The multi-dimensional rating for the creative producer based upon one or more of the active feedback and the passive feedback may be determined. The plurality of users may include one or more creative producers, one or more brands, and one or more administrators. The active feedback may include one or more of brand feedback, peer feedback, administrative feedback, and interface usage.

### CROSS REFERENCE TO RELATED APPLICATIONS

This application claims the benefit of priority to U.S. Provisional Patent Application 61/653,228, filed May 30, 2012, and entitled “METHODS AND SYSTEMS FOR RATING CREATIVE PRODUCERS,” the entire contents of which are hereby incorporated by reference.

### BACKGROUND

Increasingly, the Internet is changing the way that work is performed. International communication and collaboration tools from e-mail to video conferencing to online whiteboarding have flattened the corporate world. In the past five years, through the introduction of online professional hubs, tools, and crowdsourcing communities, the flattened world has become even more compressed.

In addition to the world of traditional business communication and collaboration, creative production, specifically video production, has become accessible and democratized in a way never before imagined. Large businesses can now obtain video directly from video professionals, with costs and turnaround times that are several times lower than what was traditionally available. Small to mid-sized businesses that previously did not have adequate access to video production services due to time, budgetary, or logistical limitations can now seek out video creatives.

However, because of the expanding ease in obtaining access to video production services, it has become increasingly difficult for businesses to identify appropriate individuals to prepare video creatives. This is particularly so because of the vast number of professionals having a wide variety of skills and talents that are capable of creating creatives for individual businesses. As such, businesses have had difficulty identifying individuals with satisfactory capabilities, skills, and/or experience in particular genres or classes of video production in a cost-effective manner.

### SUMMARY

In an embodiment, a method of generating a multi-dimensional rating for a creative producer may include identifying, by a computing device, a plurality of interactions between a plurality of users and an interface, determining, by the computing device, whether active feedback has been received from at least one of the plurality of users based upon the plurality of interactions, directing, by the computing device, a memory to store the active feedback, obtaining, by the computing device, passive feedback from at least one of the plurality of users, directing, by the computing device, the memory to store the passive feedback, and determining, by the computing device, the multi-dimensional rating for the creative producer based upon one or more of the active feedback and the passive feedback. The plurality of users may include one or more creative producers, one or more brands, and one or more administrators and the active feedback may include one or more of brand feedback, peer feedback, administrative feedback, and interface usage.

In an embodiment, a system for generating a multi-dimensional rating for a creative producer may include a storage device configured to store one or more creatives in a database that is configured to be indexed for searching, a processor, and a non-transitory, processor-readable storage medium in communication with the processor. The non-transitory, processor-readable storage medium may include one or more programming instructions that, when executed, cause the processor to identify a plurality of interactions between a plurality of users and an interface, determine whether active feedback has been received from at least one of the plurality of users based upon the plurality of interactions, direct the storage device to store the active feedback, obtain passive feedback from at least one of the plurality of users, direct the storage device to store the passive feedback, and determine the multi-dimensional rating for the creative producer based upon one or more of the active feedback and the passive feedback. The plurality of users may include one or more creative producers, one or more brands, and one or more administrators. The active feedback may include one or more of brand feedback, peer feedback, administrative feedback, and interface usage.

In an embodiment, a method of selecting a creative producer for a brand may include receiving, by a computing device, a brand project request, analyzing, by the computing device, the brand project request to determine one or more parameters of the brand project request, determining, by the computing device, one or more users suited to receive the brand request based upon the one or more parameters, providing, by the computing device, a list comprising the one or more users to the brand, receiving, by the processor, at least a subset of the one or more users, providing, by the processor, a notification to the subset receiving, by the processor, an affirmative response from at least one user in the subset, and providing, by the processor, the affirmative response to the brand. The one or more users may each have a multi-dimensional rating that corresponds to at least a portion of the one or more parameters and the subset may correspond to one or more users desired by the brand.

### BRIEF DESCRIPTION OF THE DRAWINGS

FIG. 1 depicts a schematic diagram of an illustrative system for generating a multi-dimensional rating for a creative producer according to an embodiment.

FIG. 2 depicts a block diagram of an illustrative interface for generating a multi-dimensional rating for a creative producer by identifying a plurality of interactions between a plurality of users according to an embodiment.

FIG. 3 depicts a block diagram of a series of processes that may be completed by a computing device to interact with one or more users in determining and/or updating a multi-dimensional rating for a creative producer by identifying a plurality of interactions between a plurality of users according to an embodiment.

FIG. 4 depicts a block diagram of illustrative attributes and dimensions used to form a multi-dimensional rating for a creative producer according to an embodiment.

FIG. 5 depicts a flow diagram of an illustrative method for identifying creative producers to a brand according to an embodiment.

FIG. 6 depicts a block diagram of an illustrative system for identifying creative producers to a brand according to an embodiment.

FIG. 7 depicts a flow diagram of an illustrative method for identifying creative producers to a brand according to an embodiment.

FIG. 8 depicts a block diagram of an illustrative system for building a distributed creative production team according to an embodiment.

FIG. 9 depicts a flow diagram of an illustrative method for building a distributed creative production team according to an embodiment.

FIG. 10 depicts a block diagram for an illustrative system in which one user's post-interaction rating would contribute to another user's rating according to an embodiment.

FIG. 11 depicts a block diagram of an illustrative system of weighting and balancing attributes according to an embodiment.

FIG. 12 depicts a block diagram of illustrative internal hardware that may be used to contain or implement program instructions according to various embodiments.

FIG. 13 depicts a screen shot of a review mode interface according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below:

An “administrator” refers to one or more operators of an interface who have enhanced control over and access to the products and user information presented on the interface. The administrator can additionally retain control to one or more computing devices, servers, storage media, and/or the like, particularly those that are used to control the interface.

An “assignment” or a “project” refers to an opportunity for a creative production. For example, an assignment or a project may refer to a crowd sourced opportunity for one or more creative producers to submit media to be reviewed and possibly purchased by one or more brands. An assignment or a project may be presented via an interface.

A “brand” refers to an entity that requests assignments and projects and purchases media prepared by creative producers. A brand may include a registered user on an interface whose primary site participation includes requesting and purchasing creatives and critiquing creatives prepared by creative producers. A brand may also include a company or the like that is in the business of purchasing media, such as, for example, an advertising company, a company that sells services or products in need of advertising, a nonprofit company that desires to advertise for a cause, and/or the like.

A “community” refers to, among other things, a pool of users for an interface. As used herein, a community may include all users that access an interface or a subset of users that are grouped according to various interests, abilities, accomplishments, connections to other users, and/or the like.

A “creative” or “media” refers to one or more of videos, pictures, audio files, advertisement files, and other files prepared in response to a request for an advertisement. The creative or media may be uploaded to an interface as part of the preparation of the advertisement. The creative or media may be owned either by the creative producers, by a brand, or by another party. The creative or media may be viewed via a user interface by one or more users, as described in greater detail herein. The creative or media may further be rated according to various parameters, as also described in greater detail herein.

An “interface” refers to a user interface that is accessed by creative producers and advertisers. In some embodiments, the interface may be a website that is accessible via the Internet. The interface can include tools and products available to the creative producers and advertisers. The interface may include, but is not limited to, dashboards, profile pages, media pages, assignments, and projects.

A “creative producer” refers to an individual who prepares, alone or in concert with other creative producers, creatives for submission to requestors. The creative producer may be a registered user on an interface whose primary site participation includes creating and submitting creatives for assignments and projects, such as the user interface described herein. The creative producer may be enabled to interact with his or her peers, to critique creatives produced by other creative producers, and to receive critiques on his or her creatives.

“Feedback” refers to active feedback and/or passive feedback. “Active feedback” refers to information pertaining to a creative, a creative producer, a brand, a user, an entity or an individual that is directly provided by another creative producer, brand, user, entity or individual. Active feedback may be generated on an interface directly from a user interaction (such as a mouse click or a key stroke) with a user interface. Active feedback may include likes, comments, ratings, and/or the like with respect to a particular user of the interface. “Passive feedback” refers to information pertaining to a creative, a creative producer, a brand, a user, an entity or an individual that is indirectly associated with the creative, creative producer, brand, user, entity, or individual. Passive feedback may be generated from organic site processes, user data, media data, assignment meta information, and project meta information. Illustrative forms of passive feedback include views and interactions with paid placed media, individuals included in a user's professional network, and/or the like.

A “multi-dimensional rating” refers to one or more values associated with various aspects of a creative producer. Illustrative examples of the various aspects may include, but are not limited to, reputation, experience, connections to other users, and/or the like. A multi-dimensional rating may be determined based on a profile for the creative producer and ratings offered by an at-large community.

A “primary dimension” refers to a top-level designation for a multi-dimensional rating, as described in greater detail herein. A “secondary dimension” refers to a secondary-level designation for a multi-dimensional rating, as described in greater detail herein. A secondary dimension may be associated with one primary dimension. Alternately, a secondary dimension may be associated with a plurality of primary dimensions.

An “attribute” refers to an action that provides feedback that influences a multi-dimensional rating. An attribute may be either active or passive. An attribute may be associated with one secondary dimension. Alternately, an attribute may be associated with a plurality of secondary dimensions.

An “electronic device” refers to a device, such as, for example, a mobile device, a computing device, a server, and one or more components thereof. In some embodiments, the electronic device includes a processor and a tangible, non-transitory, computer-readable memory. The memory may contain programming instructions that, when executed by the processor, cause the computing device to perform one or more operations according to the programming instructions. In some embodiments, the electronic device may be connected to a communications network, such as, for example, the Internet, an intranet, a personal area network, a home area network, a storage area network, a campus area network, a backbone network, a metropolitan area network, a wide area network, a virtual private network, and/or the like.

A “mobile device” refers to an electronic device that is generally portable in size and nature. Accordingly, a user may transport a mobile device with relative ease. Examples of mobile devices include, but are not limited to, pagers, cellular phones, feature phones, smartphones, personal digital assistants (PDAs), cameras, tablet computers, phone-tablet hybrid devices (e.g., “phablets”), laptop computers, netbooks, ultrabooks, global positioning satellite (GPS) navigation devices, in-dash automotive components, media players, watches, handheld imaging devices, personal medical devices, and/or the like.

A “computing device” is an electronic device and/or a mobile device, such as, for example, a computer or components thereof. The computing device may generally contain a memory or other storage device for housing programming instructions, data or information regarding a plurality of applications, data or information regarding a plurality of electronic devices and/or the like. The programming instructions may be in the form of an application environment, as described in greater detail herein, and/or contain one or more modules, such as software modules for carrying out tasks as described in greater detail herein. The data may optionally be contained on a database, which is stored in the memory or other storage device. The data may optionally be secured by any method now known or later developed for securing data. The computing device may further be in operable communication with one or more electronic devices. The communication between the computing device and each of the one or more electronic devices may further be secured by any method now known or later developed for securing transmissions or other forms of communication.

A “server” is a computing device or component thereof that generally provides data storage capabilities for one or more computing devices. The server can be independently operable from other computing devices and may optionally be configured to store data in a database, a memory, or another storage device. The server may optionally contain one or more programming instructions, such as programming instructions in the form of an operating environment or a user interface, as described in greater detail herein, and/or one or more modules, such as software modules for carrying out processes as described in greater detail herein. The server may have one or more security features to ensure the security of data stored within the memory or other storage device. Examples of security features may include, but are not limited to, encryption features, authentication features, password protection features, redundant data features and/or any other security features now known or later developed. The server may optionally be in operable communication with any of the electronic devices and/or computing devices described herein and may further be secured by any method now known or later developed for securing transmissions or other forms of communication.

The present disclosure identifies systems and methods for solving the above-listed problems by gathering information about creative producers, such as video professionals, and assigning each creative producer a multi-dimensional rating corresponding to, for example and without limitation, the producer's skill, reliability, and social popularity for the producer and the media that the producer produces.

Businesses seeking to employ creative producers to prepare advertisements may use the multi-dimensional rating to validate a producer's production ability. A business may compare its needs with respect to particular attributes, such as creative brief interpretation, cinematography, and post-production editing against a user's work history, and the ranking of various producers in a pool of creative producers using the multi-dimensional rating.

Advertisers can also use the multi-dimensional rating to gain insight into a creative producer's communication style and tendencies. The rating may be used to track how responsive a creative producer has been on past projects and assignments, as well as previous businesses' ratings of that producer's communication style and tendencies.

Moreover, advertisers may use the multi-dimensional rating to evaluate the past performance of media that a producer has produced. Loads, views, and conversions on owned and placed media as well as a producer's popularity on social and professional networks may contribute to a producer's rating.

The systems and methods disclosed herein may also provide value for creative producers by allowing them to search and filter their peers in order to form distributed teams according to the needs of a specific project or an ongoing opportunity.

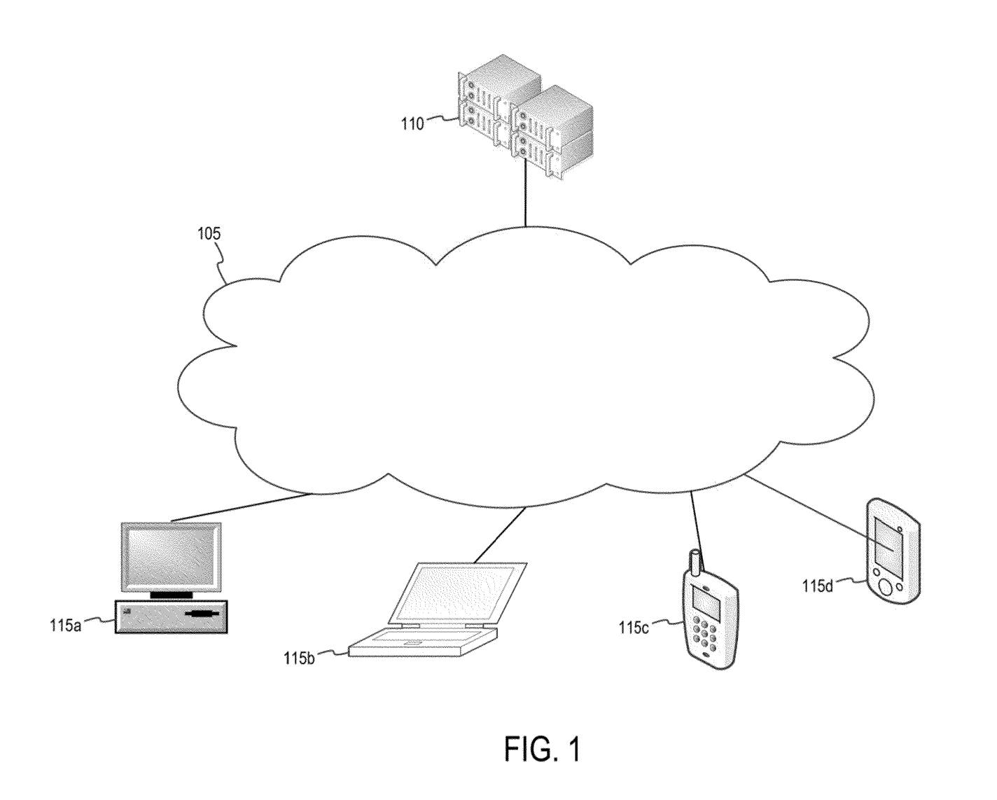

FIG. 1 depicts a schematic diagram of an illustrative system for generating a multi-dimensional rating for a creative producer according to an embodiment. As shown in FIG. 1, one or more computing devices 110, such as servers or the like, may contain programming instructions that direct a processor to complete various steps, as will be described in greater detail herein. The various programming instructions may generally include providing a user interface for one or more users, including, but not limited to, a creative producer, an administrator, a reviewer, a website user, a person working on behalf of a brand, and the like. The user interface is not limited by this disclosure, and may be any type of interface that provides some user interaction with the one or more computing devices 110. An illustrative user interface may include an Internet-based user interface 105, such as an Internet website. With the Internet-based user interface 105, a user may interact with the one or more computing devices 110 and/or one or more other devices via a client device 115. Illustrative examples of client devices may include, for example, personal computers 115a, laptop computers 115b, mobile devices 115c, 115d, and/or the like.

In some embodiments, the one or more computing devices 110 may further incorporate or be in communication with one or more storage devices that are at least configured to store one or more creatives in a database that is indexable for searching. Illustrative examples of the storage devices may include any number or combination of hard disks, removable disks, memories, databases, and/or the like.

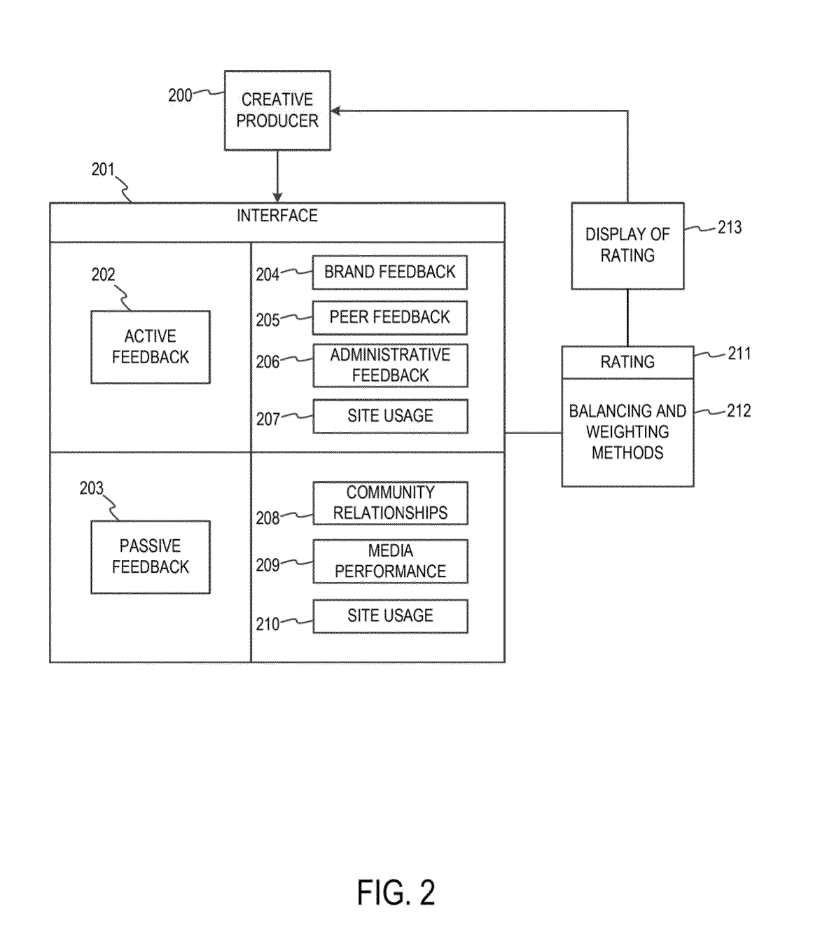

FIG. 2 depicts a block diagram of an illustrative interface for generating a multi-dimensional rating for a creative producer by identifying a plurality of interactions between a plurality of users according to an embodiment. As shown in FIG. 2, the system measures interactions between one or more creative producers 200, one or more brands, and/or one or more administrators with a user interface 201 that provides a multi-dimensional rating. The creative producer 200 may generally be a user of one or more of the client devices 115 (FIG. 1). In various embodiments, the creative producer 200 may receive active feedback 202 and/or passive feedback 203 from other users of the interface 201. In some embodiments, each other user of the interface 201 may also generally be a user of one or more of the client devices 115 (FIG. 1).

In various embodiments, the active feedback 202 may include feedback that is generated from any type of action directly initiated by a user of the interface 201. For example, the active feedback 202 may include, but is not limited to, one or more of brand feedback 204, peer feedback 205, administrative feedback 206, and/or interface usage 207.

Brand feedback 204 may include, but is not limited to, a purchase of a creative prepared by the creative producer 200 by a brand, an approval of a creative, a brand-awarded medal, a brand-awarded rating, and/or the like.

Peer feedback 205 may include, but is not limited to, a purchase of a creative prepared by a creative producer 200, an approval of a creative prepared by a creative producer, feedback of a creative prepared by a creative producer, likes for a creative prepared by a creative producer, comments to a creative prepared by a creative producer, a rating of a creative prepared by a creative producer, inclusion of a creative and/or a creative producer in a social network, inclusion of a creative and/or a creative producer in a professional network, a peer-awarded medal, a peer-awarded rating, and/or the like. In some embodiments, the peer feedback 205 may come from other users. In particular embodiments, the peer feedback 205 may come from other creative producers, industry professionals, advertisers, and/or the like.

Administrative feedback 206 may include, but is not limited to, an approval of a creative prepared by the creative producer 200 by an administrator, flagging of communication and media by the administrator, an award presented to the creative producer, a rating provided for the creative producer, an administrator-awarded medal, an administrator-awarded rating, and/or the like.

Interface usage 207 may include, but is not limited to, any type of personal interactions between the creative producer 200 and the interface 201. Illustrative personal interactions may include, for example, uploads, comments, profile setup, profile modifications, page views of various content pages and/or the like, participation in assignments and projects, and/or the like.

Passive feedback 203 may include information that is generated indirectly with respect to the creative producer 200. For example, passive feedback 203 may include, but is not limited to, community relationships 208, media performance 209, and interface usage 210.

Community relationships 208 may refer to any relationship between a creative producer 200 and the creative producer's professional and/or social network. For example, the community relationships 208 for a creative producer 200 may be affected by one or more multi-dimensional rating values for users that are in the creative producer's professional network, a demographic makeup of the creative producer's professional network, the site activity of the creative producer's professional network, and/or the like.

Media performance 209 may refer to the performance of media that a creative producer 200 has provided to the interface in terms of paid and owned views, paid and owned conversions of the media, media meta-information, such as a length, a file type, and/or the like. Additional or alternate information may be used to determine media performance 209 for the creative producer 200 within the scope of this disclosure.

Interface usage 210 may refer to additional background information stored with respect to the interaction between the creative producer 200 and/or members of the professional network of the creative producer with the interface 201.

In various embodiments, the compiled active feedback 202 and passive feedback 203 attributes for the creative producer 200 may be balanced against each other and weighted 212 against the compiled feedback of the community to determine a multi-dimensional rating 211 for the creative producer. The multi-dimensional rating 211 for the creative producer 200 may be displayed to the creative producer and/or one or more other users of the interface 201.

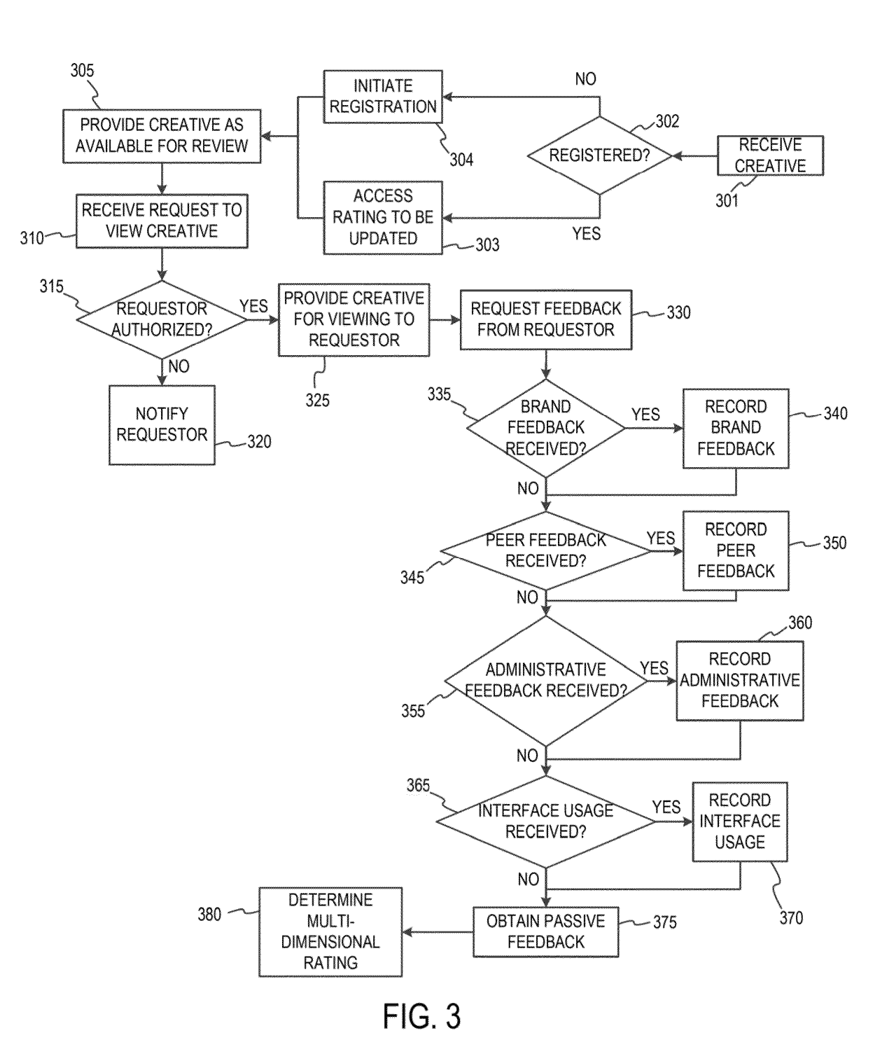

FIG. 3 depicts a block diagram of a series of processes that may be completed by a computing device to interact with one or more users in determining and/or updating the multi-dimensional rating 211 (FIG. 2) for the creative producer 200 by identifying a plurality of interactions between a plurality of users according to an embodiment. In various embodiments, the computing device may receive 302 the creative. In some embodiments, the creative may be received 302, for example, via the interface 201 (FIG. 2). In some embodiments, the creative may be received 302 from, for example, the creative producer, an agent or representative of the creative producer, a collective of creative producers, and/or the like.

In various embodiments, the computing device may determine 302 whether the creative producer(s) associated with the creative are registered as creative producer(s). This may be completed generally to determine whether the creative producer(s) have previously interacted with the interface to provide ratings, upload creatives, and/or the like. This may also be completed to determine whether a multi-dimensional rating has previously been created for the creative producer(s). In some embodiments, the computing device may determine 302 whether the creative producer(s) associated with the creative are registered by communicating with a database, such as a database on the storage device. The storage device may be integrated with the computing device or may be connected to the computing device via a remote connection. Remotely connected storage devices may include, for example, remote servers, cloud computing devices, backup drives, and/or the like. If a multi-dimensional rating already exists for one or more of the creative producers, the computing device may access 303 the multi-dimensional rating for further updating based upon the newly submitted creative. If a multi-dimensional rating does not exist for the one or more creative producers, the computing device may initiate 304 a registration process for each of the one or more creative producers. The registration process may include, for example, information about the creative producer such as contact information, information regarding associated creative producers, information regarding one or more entities with which the creative producer may be affiliated or related, demographic information about the creative producer, login information that allows the creative producer to access the interface 201 (FIG. 2), and/or the like.

In various embodiments, the computing device may provide 305 the creative and/or information about the creative for review in order to identify a plurality of interactions as described herein. In some embodiments, the computing device may provide 305 the creative by posting a link to the creative, a description of the creative, a description of the creative producer that created the creative, and/or the like to the interface for various users to view the creative. In some embodiments, the user must click on a link or complete a similar action to activate a request to view the creative before it will be provided to the user. Thus, the computing device may receive 310 one or more requests to view the creative and may determine 315 whether the requestor is authorized to view the creative. For example, in some embodiments, a requestor may be required to sign in to verify his/her identity before he/she is authorized to view creatives. In other illustrative embodiments, only particular requestors may be authorized to view the creatives, such as in instances where creatives are targeted towards specific users or creatives are created in response to a request from a particular user. In yet other illustrative embodiments, all users may be authorized to view the creative. In some embodiments, the computing device may determine 315 whether users are authorized to view the creative prior to providing 305 the creative to users as available for review. In such embodiments, the creative may only be viewable to authorized users and may not be viewable (i.e., may be not visible or may not appear to exist) to unauthorized users. Thus, when a user clicks on a link or completes a similar action as previously described herein, the creative may automatically begin playing if the requestor is authorized.

In various embodiments, if the requestor is not authorized, the computing device may notify 320 the requestor. The notification may include, for example, a notice that the requestor is not authorized, and may further provide one or more reasons for why the requestor is not authorized. In some embodiments, the requestor may be provided with options for becoming authorized, such as, for example, by providing a registration link, an email address to contact, a phone number to contact, and/or the like.

In various embodiments, if the requestor is authorized, the computing device may provide 325 the creative for viewing to the requestor. In some embodiments, the computing device may provide 325 the creative by presenting the creative via the interface. For example, in instances where the creative is a video, the computing device may stream the video via the interface so that the requestor can view the creative in real time on his/her electronic device. In another example, the computing device may provide the creative in a review mode, as described in greater detail herein. In yet another example, where the creative is a photograph, a plurality of photographs, and/or the like, the computing device may display the creative on the interface for the requestor to view, manipulate, and/or the like. The requestor may manipulate the creative by, for example, panning, zooming, rotating, flipping between pages, and/or the like. In other embodiments, the computing device may provide 325 the creative by transmitting the creative to the requestor or permitting the requestor to receive a copy of the creative. For example, the creative may be available as an electronic file that the requestor can download for viewing on the requestor's electronic device at any time, or the creative may be sent to the requestor, such as, for example, via email, via facsimile, via postal mail, and/or the like.

Once the requestor has reviewed the creative, the computing device may request 330 that the requestor provide feedback regarding the creative. In some embodiments, the computing device may obtain feedback as it is provided by the requestor, particularly in instances where passive feedback is provided, as described in greater detail herein. The request 330 may be in the form of an online questionnaire, providing an ability to receive commentary, providing “like” buttons, providing message board and/or instant chat functionality, and/or the like. In some embodiments, the computing device may merely identify and monitor interactions between the requestor, the creative producer, one or more brands, and/or other users to obtain feedback.

In various embodiments, the computing device may determine 335 whether brand feedback was received from the requestor regarding the creative. If brand feedback was received, the computing device may record 340 the brand feedback. The computing device may record 340 the brand feedback by directing a storage device to store the brand feedback, or by directing a storage device to modify an existing electronic file to include the brand feedback.

In various embodiments, the computing device may determine 345 whether peer feedback was received from the requestor regarding the creative. If peer feedback was received, the computing device may record 350 the peer feedback. As previously described, the computing device may record 350 the peer feedback by directing a storage device to store the peer feedback, or by directing a storage device to modify an existing electronic file to include the peer feedback. In some embodiments, the computing device may further combine the brand feedback with the peer feedback.

In various embodiments, the computing device may determine 355 whether administrative feedback was received from the requestor regarding the creative. If administrative feedback was received, the computing device may record 360 the administrative feedback by directing a storage device to store the administrative feedback, or by directing a storage device to modify an existing electronic file to include the administrative feedback. In some embodiments, the computing device may further combine the administrative feedback with the brand feedback and/or the peer feedback.

In various embodiments, the computing device may determine 365 whether interface usage was received. If interface usage was received, the computing device may record 370 the interface usage by directing a storage device to store the interface usage, or by directing a storage device to modify an existing electronic file to include the interface usage. In some embodiments, the computing device may further combine the interface usage with the brand feedback, the peer feedback, and/or the administrative feedback.

In various embodiments, the computing device may obtain 375 passive feedback from the requestor, as described in greater detail herein. The computing device may generally obtain 375 the feedback by directing a storage device to store the passive feedback, or by directing a storage device to modify an existing electronic file to include the passive feedback. In some embodiments, the computing device may further combine the passive feedback from one or more of the interface usage, the administrative feedback, the brand feedback, and the peer feedback.

Once all of the feedback is recorded, the computing device may determine 380 the multi-dimensional rating for the creative producer. In some embodiments, this may include updating a previously created multi-dimensional rating with new information. In other embodiments, this may include determining 380 a new multi-dimensional rating for the creative producer. The computing device may generally determine 380 the multi-dimensional rating by using various attributes and dimensions as described in greater detail herein.

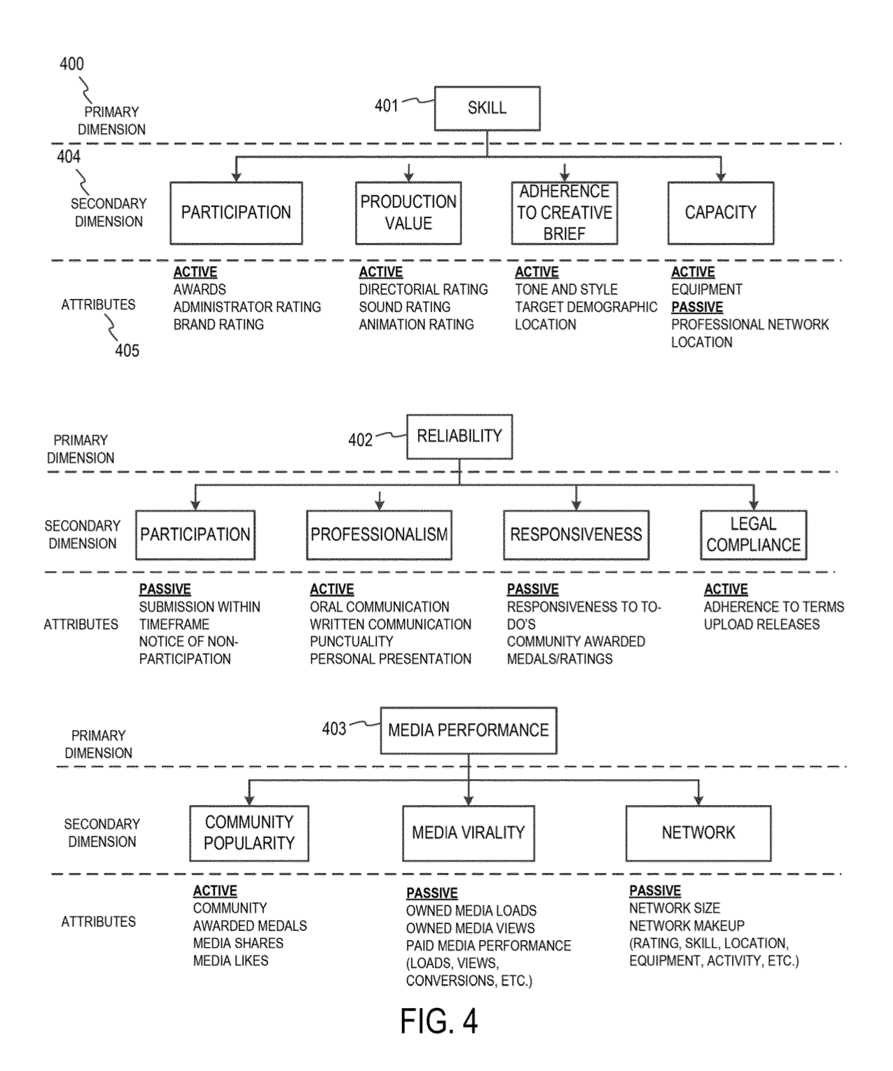

FIG. 4 depicts a block diagram of illustrative attributes and dimensions used to form a multi-dimensional rating for a creative producer according to an embodiment. As shown in FIG. 4, the attributes and dimensions of the multi-dimensional rating may be used to identify a global rating value that is determined based on one or more primary dimensions 400. In an embodiment, the primary dimensions 400 may include, but are not limited to, a skill rating 401 for a creative producer, such as the creative producer 200 (FIG. 2), a reliability 402 for the creative producer, and a media performance 403 for the creative producer. Additional and/or alternate primary dimensions 400 may be used within the scope of this disclosure.

Each primary dimension 400 may be comprised of one or more secondary dimensions 404. Each secondary dimension 404 associated with a primary dimension 400 may be contextually related to the primary dimension with which it is associated. For example, the skill primary dimension 401 may contain secondary dimensions 404 related to the skill of execution-focused production value, conceptually focused adherence to a creative brief designating the scope of a requested creative, and/or the like.

Each secondary dimension 404 may include one or more attributes 405 that are assigned an associated score value. The values for each attribute 405 of a secondary dimension 404 may be balanced and weighted with respect to each other in order to compose a score for the secondary dimension. Likewise, the scores for the secondary dimensions 404 may be balanced and weighted against each other to create scores for the primary dimensions 400. The balanced and weighted primary dimensions 400 may be used to compose the multi-dimensional rating for the creative producer.

Illustrative primary dimensions 400, secondary dimensions 404 and attributes 405 are identified in FIG. 4. Additional and/or alternate primary dimensions 400, secondary dimensions 404 and/or attributes 405 may be used without departing from the scope of the present disclosure. In various embodiments, the multi-dimensional rating for a creative producer may be derived from an algorithmic weighting of secondary dimensions 404 within each primary dimension 400. Various weights of each attribute 405 may be progressively optimized and tuned by the algorithm based on their correlation to each other.

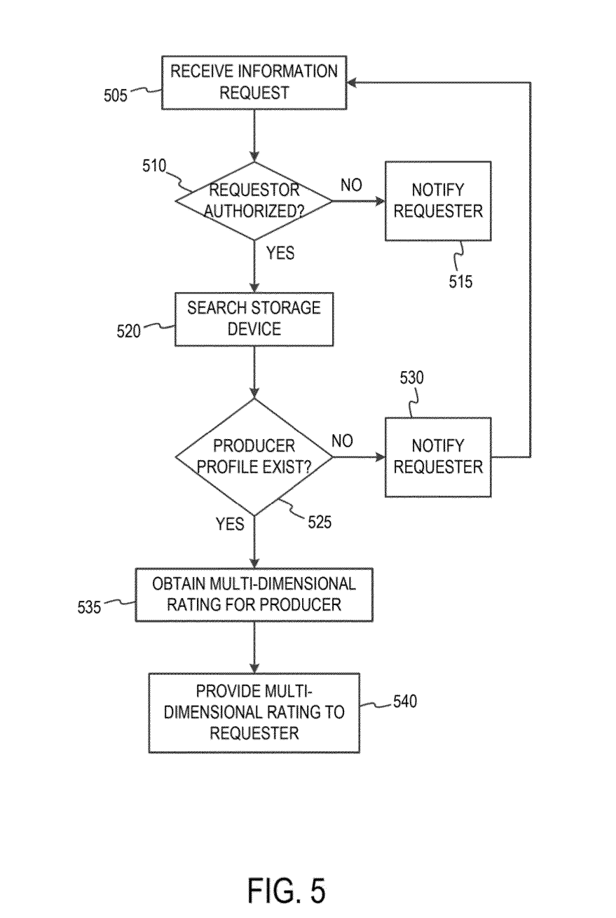

FIG. 5 depicts a flow diagram of an illustrative method for identifying creative producers to a brand according to an embodiment. In various embodiments, the computing device may receive 505 a request for information. In some embodiments, the request may be received 505 from a brand, particularly a brand that is looking for a specific type of creative producer based upon the brand's needs. In other embodiments, the request may be received 505 from a user of the interface, an administrator, and/or the like. In some embodiments, the request may generally include a request for information regarding a category of creative producers. For example, the requestor may wish to find one or more creative producers who satisfy a set of criteria, such as, for example, a level of experience, a particular demographic, a background in a particular category, and/or the like. In some embodiments, the request may not be limited to particular creative producers. For example, a requestor may desire to see all available creative producers. In some other embodiments, the request may be limited to a particular creative producer or a particular collective of creative producers. For example, the requestor may have a specific creative producer already in mind and may wish to obtain more information about the creative producer.

In some embodiments, the computing device may determine 510 whether the requestor is authorized to obtain the information contained in the request. The requestor may be authorized, for example, if he/she is registered to use the interface, as described in greater detail herein. The requestor may also be authorized if he/she has been verified as a brand, a representative of a brand, an affiliate of a brand, and/or the like. If the requestor is not authorized, the computing device may notify 515 the requestor that he/she is not authorized. The computing device may notify 515 the requestor by displaying a message in the user interface, by providing a notification via, for example, text message, email message, popup notification, and/or the like. In some embodiments, the computing device may provide the requestor with information regarding steps that the requestor can take to become authorized.

In various embodiments, the computing device may search 520 a storage device in response to receiving 505 a request. In some embodiments, the search may generally contain search criteria that corresponds to the request that was received 505, information about the requestor, particular databases and/or memories to be searched depending on the nature of the request, and/or the like. In some embodiments, the computing device may search 520 using any type of search engine and/or search method now known or later developed, such as, for example, a Boolean search, a natural language search, a keyword search, a phrase search, a fuzzy search, and/or the like.

In various embodiments, the computing device may determine 525 whether at least one creative profile exists. In some embodiments, the determination 525 may be based upon whether any creative profiles match the search criteria. In some embodiments, the determination 525 may be based upon whether any creative profile is a partial match to the search criteria. If no creative profile exists based upon the determination 525, the computing device may notify 530 the requestor that no creative profile was found. The computing device may provide the requestor with an option to revise the search to find other creative profiles based upon modified search criteria, and may return to receiving 505 an information request, as previously described herein.

If at least one creative profile exists based upon the search criteria, the computing device may obtain 535 a multi-dimensional rating for each creative profile. The multi-dimensional rating for each profile may be obtained 535 from a storage device, as previously described herein. In some embodiments, the computing device may provide 540 each multi-dimensional rating to the requestor. The computing device may also provide additional information to the requestor, such as, for example, the search results, a document, such as a report and the like, that contains various pieces of information related to the search, the matching creative profiles, the corresponding multi-dimensional ratings for each profile, and/or the like. Other additional information may include, for example, sample media provided by each creative producer that corresponds to the creative profile, contact information, search validity information, time and date of the search, copyright and trademark information, disclaimers, and/or the like.

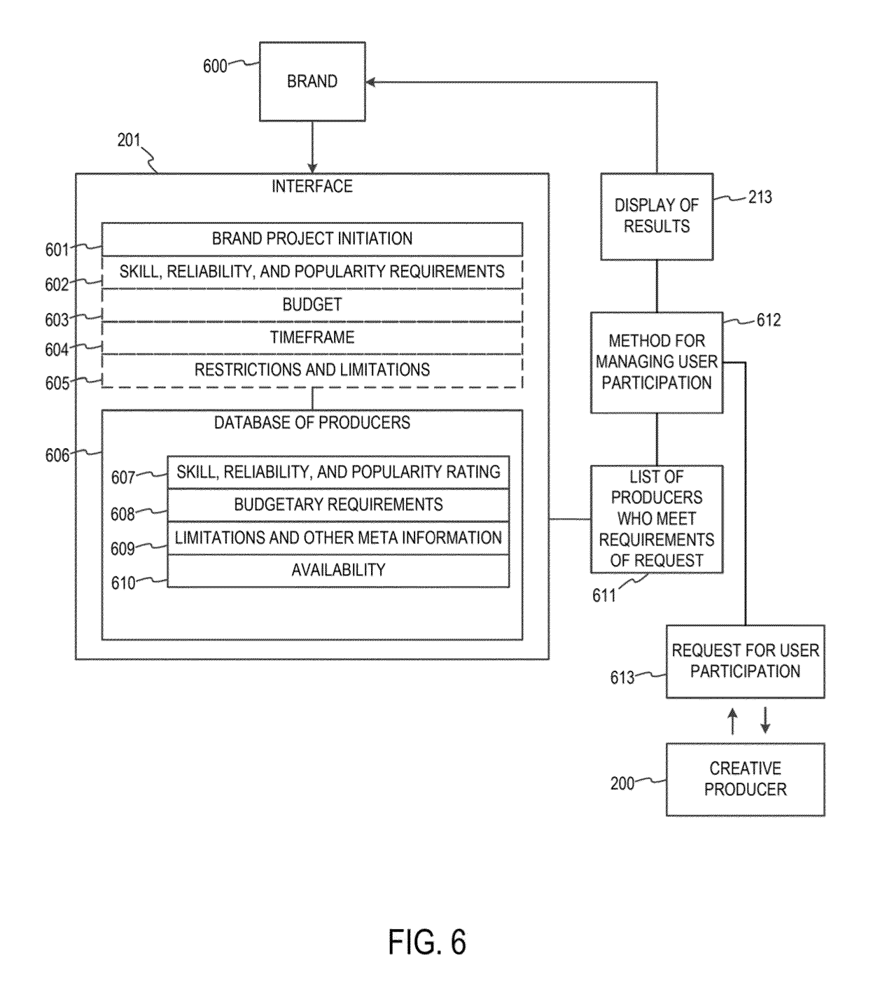

FIG. 6 depicts a block diagram of an illustrative system for identifying creative producers to a brand according to an embodiment. As shown in FIG. 6, a brand 600 may use the multi-dimensional rating when issuing a brand project request 601 for media using the user interface 201 on the interface. The brand 600 may have the ability to initiate an assignment or project on the website with a brand project request 601 that is sent to one or more creative producers. In an embodiment, the brand project request 601 may be issued to the entire community of the interface (an open project request). In an embodiment, the brand project request 601 may be issued to an identified subset of the community (a closed project request). If a closed project request is requested, one or more parameters of the brand project request 601 may define the restricted subset of the community that is recommended for the assignment or project.

The parameters for the brand project request 601 may include a desired skill, reliability and/or a media performance requirement (i.e., a primary dimension requirement 602), a budget 603, a timeframe 604 for completing the project, and/or one or more other limitations or restrictions 605 for the project, such as a location or skill set for creative producers. The parameters for the brand project request 601 may be compared with multi-dimensional rating information for one or more creative producers contained in a database 606 associated with the interface 201. For example, the database 606 may contain associated skill, reliability and media performance ratings 607, budgetary requirements 608, personal limitations and restrictions 609, and availability 610 information for each of one or more creative producers.

After comparing the parameters for the brand project request 601 with the information contained in the database 606, a list of creative producers that satisfy the parameters may be exposed to the brand 600. The brand 600 may be enabled to request 613 participation from creative producers that satisfy the requirements. In an embodiment, the multi-dimensional ratings for creative producers that satisfy the requirements for the brand project request 601 may have their multi-dimensional ratings and/or other parameters that are associated with the project or assignment, such as 607-610, displayed to the brand 600. In an embodiment, the status of requests 613 for participation may also be displayed to the brand 600.

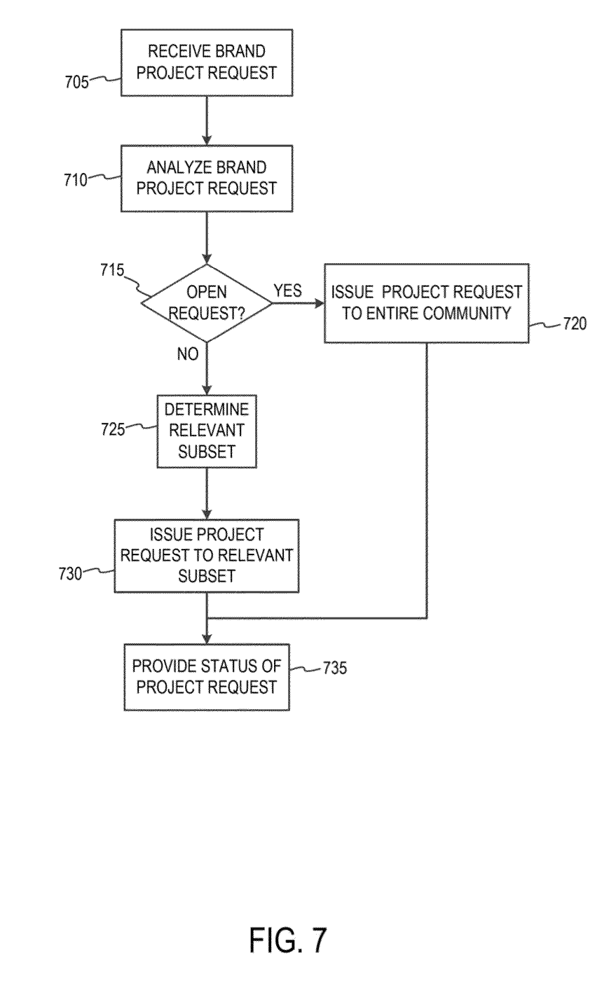

FIG. 7 depicts a flow diagram of an illustrative method for identifying creative producers to a brand according to an embodiment. In various embodiments, the computing device may receive 705 a brand project request. In some embodiments, the brand project request may be received 705 from a brand, a representative of a brand, an affiliate of a brand, a subsidiary of a brand, and/or the like. In some embodiments, the brand project request may be received 705 via the interface. In other embodiments, the brand project request may be received 705 via a direct submission of the request from a brand to the computing device or an administrator. Examples of a direct submission may include, but are not limited to, telephone-submitted requests, email-submitted requests, form-submitted requests, facsimile-submitted requests, personally submitted requests, and/or the like.

In some embodiments, the computing device may analyze 710 the brand project request. The brand project request may be analyzed to determine one or more parameters of the brand project request. Illustrative examples of parameters may include various categories of the request, an intended audience and/or demographic of the request, a desired creative producer or collective of creative producers to respond to the request, and/or the like. In analyzing 710 the project request, the computing device may additionally determine 715 whether the project request should be an open project request. The determination 715 may be based upon the nature of the project request, whether the brand desires the project request to be open, whether the project request is suited to be open, and/or the like. If the computing device determines 715 that the project request should be an open request, it may issue 720 the project request to the entire project community as an open project request. In some embodiments, the entire community may include any user that accesses the interface. In other embodiments, the entire community may only include users that are registered to use the interface. The entire community may have the capability to view and/or review the open project request and any items related to the open project request, as described in greater detail herein.

If the computing device determines 715 that the request should not be an open project request (i.e., a closed project request), the computing device may determine 725 a relevant subset of users to which the closed project request is viewable. This determination 725 may be based upon the analysis 710 of the project request, as previously described herein. However, this determination 725 is not limited to particular factors listed herein; rather any factors, whether or not specifically listed herein, may be used to determine the relevant subset of users.

Once the relevant subset of users has been determined 725, the computing device may issue 730 the project request to the relevant subset of users. Issuing 730 the project request may generally be completed by enabling the users in the relevant subset to review and respond to the project request. In some embodiments, the computing device may issue 730 the project request by providing a notification to each user in the relevant subset. In other embodiments, the issuing 730 may be passive. For example, the computing device may make the project request available to the subset of users, but may not necessarily notify the subset that the project request is available for viewing. In some embodiments, the computing device may issue 730 the project request by providing the project request and any related information, as described in greater detail herein, to each user in the subset via the interface.

In various embodiments, the computing device may also display 735 the status of the issued project request. This may generally be completed so that each user that reviews the project request may determine whether the project request has been claimed. In some embodiments, the identity of the creative producer that claimed the project request may also be available. The computing device may provide 735 the status of the issued project request to all users or a subset of users, such as, for example, the subset of users selected for a closed project request.

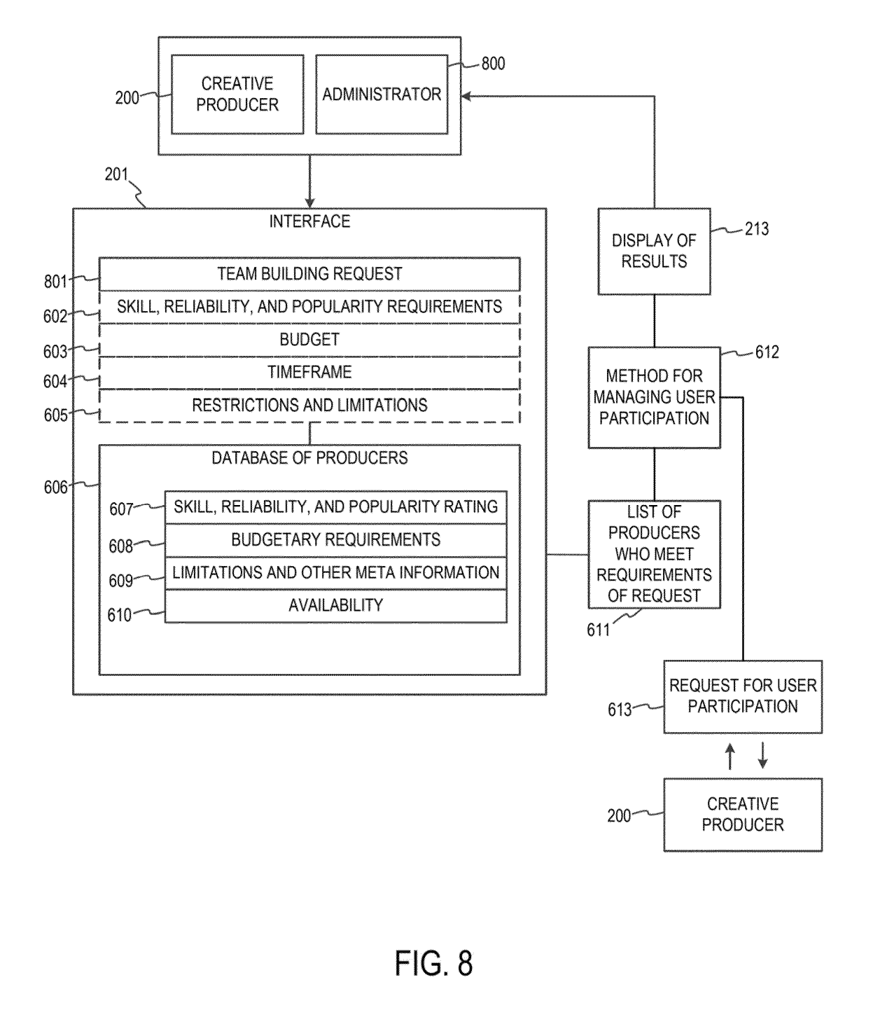

FIG. 8 depicts a block diagram of an illustrative system for building a distributed creative production team according to an embodiment. As shown in FIG. 8, a creative producer 200 or an administrator 800 may use the multi-dimensional rating system to assemble a production team. The creative producer 200 or administrator 800 may issue a team building request 801 for media incorporating a plurality of parameters used to search the database 606 described above in reference to FIG. 6. The parameters used to perform the search may be based on needs perceived to be required for producing a creative. For example, the parameters of a team building request 801 may define a restricted subset of the community that would be recommended for an assignment or project.

The parameters for the team building request 801 may include a desired skill, reliability and/or a media performance requirement (i.e., a primary dimension requirement 602), a budget 603, a timeframe 604 for completing the project, and/or one or more other limitations or restrictions 605 for the project, such as a location or skill set for creative producers. The parameters for the team building request 801 may be compared with multi-dimensional rating information for a plurality of creative producers contained in a database 606 associated with the interface 201. For example, the database 606 may contain associated skill, reliability and media performance ratings 607, budgetary requirements 608, personal limitations and restrictions 609, and availability 610 information for each of a plurality of creative producers.

After comparing the parameters for the team building request 801 with the information contained in the database 606, a list of creative producers that satisfy the parameters may be exposed to the creative producer 200 or administrator 800 making the request. The creative producer 200 or administrator 800 may be enabled to request 613 participation from creative producers that satisfy the requirements. In an embodiment, the multi-dimensional ratings for creative producers that satisfy the requirements for the team building request 801 may have their multi-dimensional ratings and/or other parameters that are associated with the project or assignment, such as 607-610, displayed to the creative producer 200 or administrator 800. In an embodiment, the status of requests 613 for participation may also be displayed to the creative producer 200 or administrator 800.

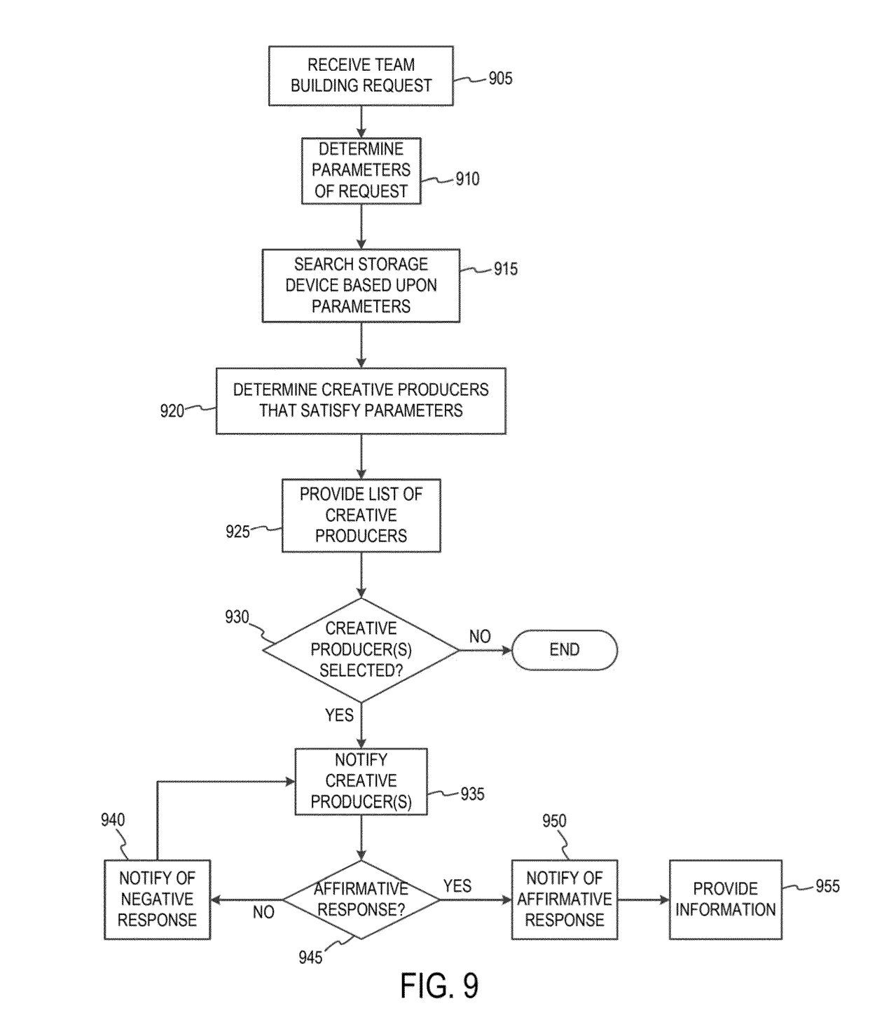

FIG. 9 depicts a flow diagram of an illustrative method for building a distributed creative production team according to an embodiment. The computing device may receive 905 a team building request. The request may generally be received 905 from a requestor, such as a brand, a representative of a brand, an affiliate of a brand, a subsidiary of a brand, and/or the like. In some embodiments, the team building request may be received 905 via the interface. In other embodiments, the team building request may be received 905 via a direct submission of the request from a brand to the computing device or an administrator. Examples of a direct submission may include, but are not limited to, telephone-submitted requests, email-submitted requests, form-submitted requests, facsimile-submitted requests, personally submitted requests, and/or the like.

In various embodiments, the computing device may determine 910 one or more parameters of the team building request. The one or more parameters of the team building request is not limited by this disclosure, and may generally be any parameters that describe the team building request. Illustrative examples may include a request category, an intended audience, an intended demographic, a desired creative producer or collective of creative producers, a desired category of creative producer or collective of creative producers, a desired number of creative producers, a desired expertise of a creative producer or collective of creative producers, and/or the like.

Once the parameters have been determined 910, the computing device may search 915 a storage device to determine 920 a list of creative parameters that satisfy the parameters of the team building request. In some embodiments, the list may include only creative producers that satisfy all of the parameters. In other embodiments, the list may include creative producers that satisfy at least a portion of the parameters. In these embodiments, the list may rank the creative producers based upon how many of the parameters they satisfy.

In various embodiments, the computing device may provide 925 the list of creative producers that satisfy the parameters to the requestor. In some embodiments, the computing device may provide 925 the list by directing a display, such as the interface or the like, to display the list of the creative producers that satisfy the parameters.

Once the list of creative producers that satisfy the parameters has been provided 925, the computing device may determine 930 whether any of the creative producers from the list were selected. This may generally be completed by receiving an affirmative selection from the requestor. The affirmative selection may be via the interface, such as when the requestor selects one or more creative producers in the list in the interface.

If no creative producers are selected, the process may end without any further action. If at least one creative producer is selected, the computing device may notify 935 each selected creative producer. The notification is not limited by this disclosure, and may generally include a notification that the requestor is interested in working with the creative producer to create a creative. In some embodiments, the notification may include information about the requestor, the nature of the request, a description of a desired creative sought, the parameters of the team building request, an identification of other potential creative producers, and/or the like. The notification may be displayed on the interface when a creative producer accesses the interface or may be sent as a message to the creative producer, such as a text message, an email message, a facsimile message, an instant message, a video chat message, a telephone message, and/or the like.

In various embodiments, the computing device may determine 945 whether an affirmative response has been received from each of the creative producers that were notified 935. If no response is received, or if a negative response is received, the computing device may notify 940 the requestor of the negative response or the failure to respond. In instances where no response is received, the computing device may only notify 940 the requestor after a period of time has elapsed since the creative producer was notified 935. For example, the computing device may notify 940 the requestor after 1 hour, 12 hours, 1 day, 2 days, 3 days, 5 days, 7 days, 10 days, 14 days, 30 days, 60 days, 90 days, 120 days, 1 year, or any range of values between any two of these values. In some embodiments, the computing device may only notify 940 the requestor after a period of time has elapsed that the requestor has specified. For example, the requestor may specify that he/she would like to be notified after a period of time has elapsed in which the creative producer has not responded, such as, for example, after 1 hour, 12 hours, 1 day, 2 days, 3 days, 5 days, 7 days, 10 days, 14 days, 30 days, 60 days, 90 days, 120 days, 1 year, or any range of values between any two of these values. In some embodiments, the computing device may notify 935 each nonresponsive creative producer one or more additional times so as to remind the creative producer to respond.

If the computing device determines 945 that an affirmative response has been received from at least one of the creative producers, the computing device may notify 950 the requestor of the affirmative response and provide 955 information to the requestor. The information is not limited by this disclosure, and may generally include information about each of the creative producers that provided an affirmative response. Such information may include, for example, names, addresses, telephone numbers, email addresses, other contact information, demographic information, affiliated companies, contact information for third parties such as an assistant of the creative producer, and/or the like.

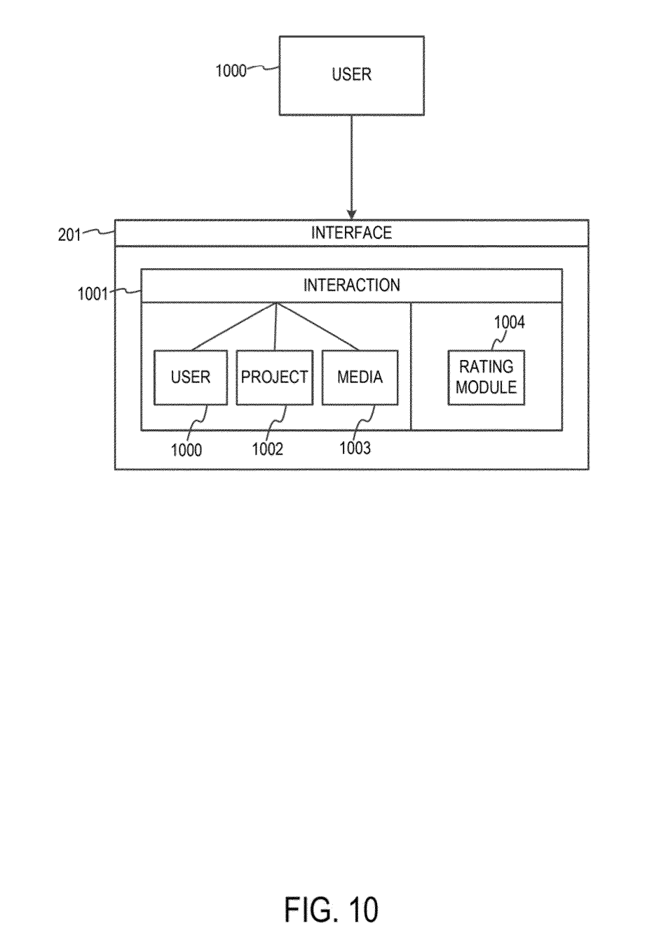

FIG. 10 depicts a block diagram for an illustrative system in which one user's post-interaction rating would contribute to another user's rating according to an embodiment. As shown in FIG. 10, a user 1000 may influence the multi-dimensional ratings of other users within the community by rating interactions 1001 with various users and systems through a portable rating module 1004. For example, a user 1000 may have the ability to interact with other people and systems through the user interface 201, such as other users, assignments and projects 1002, media 1003 and/or the like. In an embodiment, interactions between a user 1000 and other users may include, without limitation, discussions, comments, “likes”, and/or the like. In an embodiment, interactions regarding assignments and/or projects 1002 may include, without limitation, media production and submission by a creative producer, distribution of projects to various creative producers and/or the like. In an embodiment, interactions regarding media 1003 may include media views by members of the community, comparisons between various media, and/or the like.

After an interaction with one or more of these people or systems, a user 1000 may rate the interaction using a portable rating module 1004. In an embodiment, the portable rating module 1004 may be used to rate one or more of a user, a creative producer, a brand, an interaction, media, and/or the like. A rating submitted by the user 1000 using the portable rating module 1004 may be submitted as active feedback for the corresponding people or systems and as passive feedback to other people or systems.

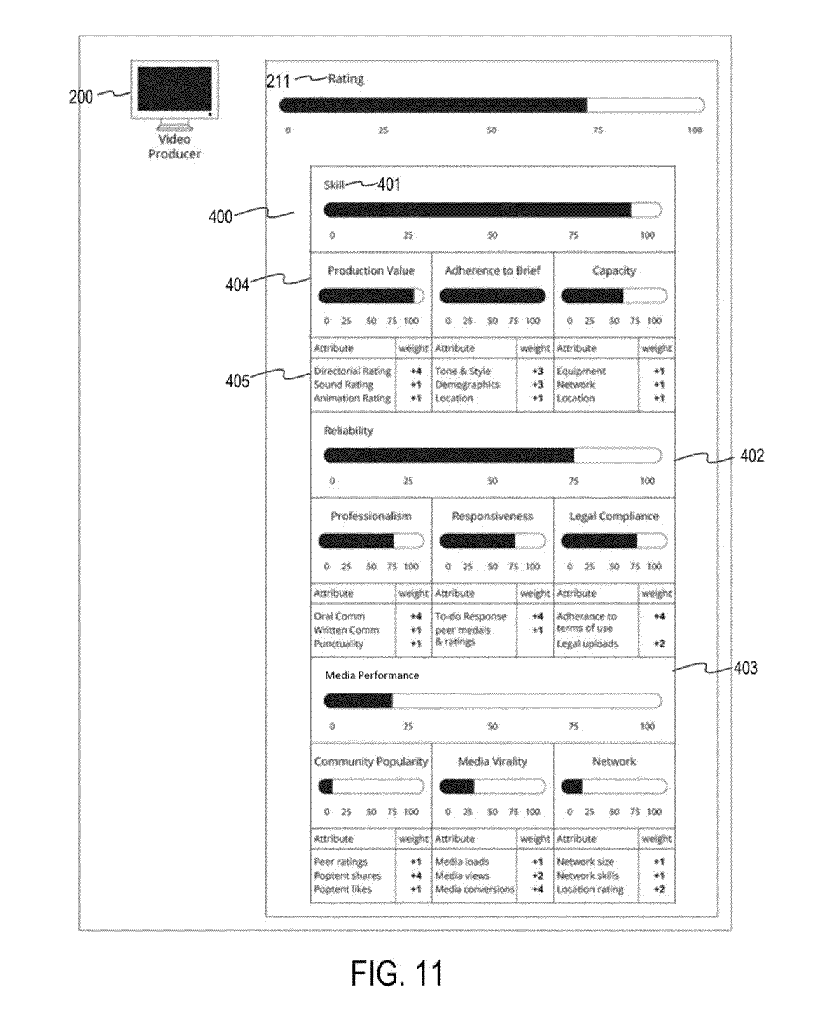

FIG. 11 depicts a block diagram of an illustrative system of weighting and balancing attributes according to an embodiment. As shown in FIG. 11, a multi-dimensional rating 211 for a creative producer 200 may include weighted and balanced values. The creative producer's 200 top level rating of the multi-dimensional rating 211 may contain a plurality of scored primary dimensions 400. The primary dimensions 400 may each be composed of a plurality of scored secondary dimensions 404. The secondary dimensions 404 may, in turn, contain one or more scored attributes 405 based on active feedback 202 and/or passive feedback 203 (FIG. 2). These weighting of these attributes 405 may be modified in accordance with the value placed on an attribute as compared to other attributes. In an embodiment, an administrator 800 (FIG. 8) may assign a set of default values for the weights applied to the attributes 405. In an embodiment, a brand 600 (FIG. 6) may apply values for weights applied to the attributes 405 based on the needs for a particular project or assignment. Additional and/or alternate ways of assigning weights to attributes 405 may be performed within the scope of this disclosure.

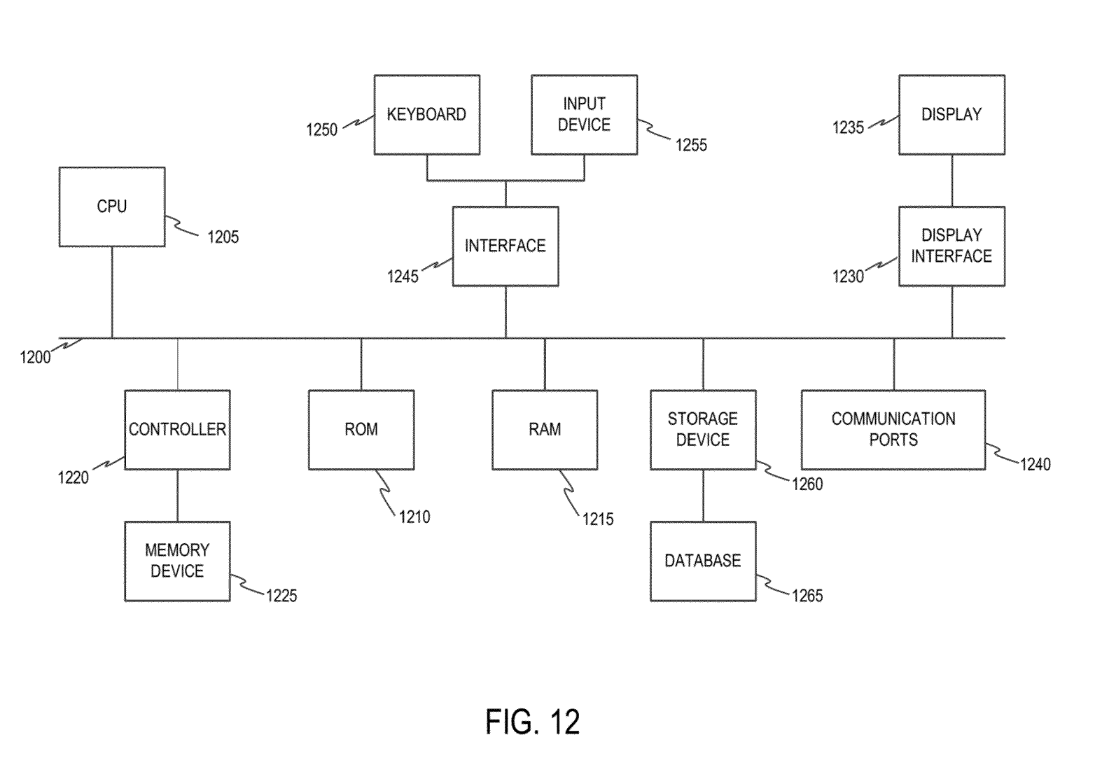

FIG. 12 depicts a block diagram of illustrative internal hardware that may be used to contain or implement program instructions, such as the process steps discussed herein, according to various embodiments. A bus 1200 may serve as the main information highway interconnecting the other illustrated components of the hardware. A CPU 1205 is the central processing unit of the system, performing calculations and logic operations required to execute a program. The CPU 1205, alone or in conjunction with one or more of the other elements disclosed in FIG. 12, is an illustrative processing device, computing device or processor as such terms are used within this disclosure. Read only memory (ROM) 1210 and random access memory (RAM) 1215 constitute illustrative memory devices (i.e., processor-readable non-transitory storage media).

A controller 1220 interfaces with one or more optional memory devices 1225 to the system bus 1200. These memory devices 1225 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 1210 and/or the RAM 1215. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 1230 may permit information from the bus 1200 to be displayed on the display 1235 in audio, visual, graphic, or alphanumeric format, such as the interface previously described herein. Communication with external devices, such as a print device, may occur using various communication ports 1240. An illustrative communication port 1240 may be attached to a communications network, such as the Internet, an intranet, or the like.

The hardware may also include an interface 1245 which allows for receipt of data from input devices such as a keyboard 1250 or other input device 1255 such as a mouse, a joystick, a touch screen, a remote control, a pointing device, a video input device and/or an audio input device.

The hardware may also include a storage device 1260 such as, for example, a connected storage device, a server, and an offsite remote storage device. Illustrative offsite remote storage devices may include hard disk drives, optical drives, tape drives, cloud storage drives, and/or the like. The storage device 1260 may be configured to store data as described herein, which may optionally be stored on a database 1265. The database 1265 may be configured to store information in such a manner that it can be indexed and searched, as described herein.

The computing device of FIG. 12 and/or components thereof may be used to carry out the various processes as described in FIGS. 1-11.

### EXAMPLES

### Example 1

### Review Mode Interface

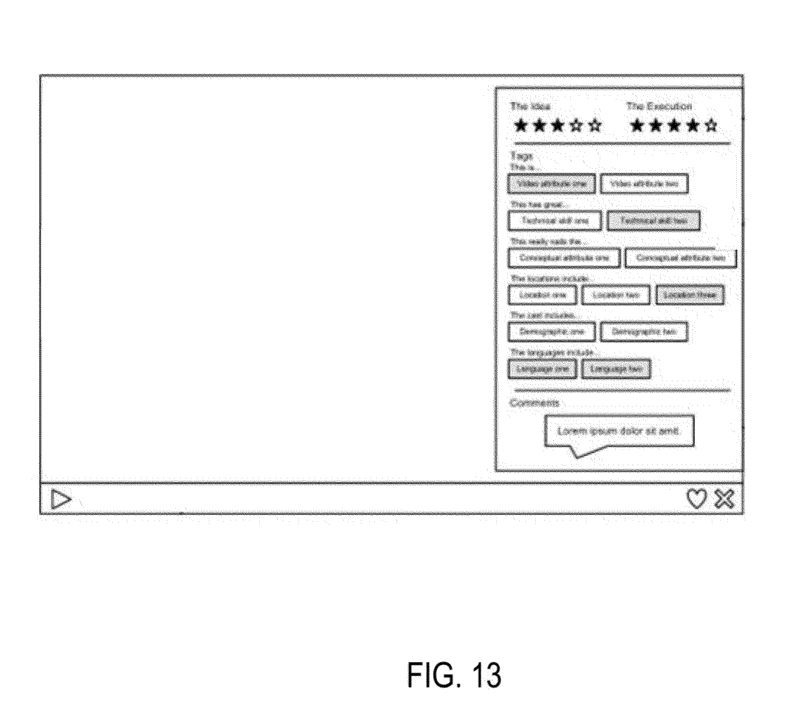

The computing device is configured to record feedback, including the active and passive feedback described herein, in a review mode interface. The review mode interface, as depicted in FIG. 13, is configured to facilitate the evaluation of video that contributes to the creative producer's rating. The review mode interface includes a full browser video player where a user is presented with a video or a series of videos, such as, for example, a playlist of videos. The review mode interface also includes one or more controls related to the evaluation of the one or more videos. The controls include, for example, scale rating controls that allow for the rating of a media's technical and conceptual quality, attribute tagging controls that allow for the association of specific attributes with a piece of media, user comments that can be analyzed for sentiment, and/or the like. Illustrative examples of the attribute tagging controls include, but are not limited to, emotional triggers and reactions to a piece of media prompts, technical skill sets showcased in the video, valuable conceptual attributes in the video, locations included in the video, access to demographics for casting, languages in a video, and/or the like.

### Example 2

### Ideation and Production Assignments

The interface described herein can include a tool that allows advertisers to procure ideas and video from a creative community. For example, an advertiser can use the interface for video ideation or production. The result of video ideation is a creative idea that is obtained in response to the advertiser's brief by using the methods described herein. The idea is a suggestion for how the advertiser may obtain its marketing objectives through video. The idea is merely an approximated rough draft, and would require editing or reshooting before it is ready for use.

Video production results in a fully executed video that speaks to the advertiser's target audience and fits the marketing need. Not only is the concept fully fleshed out, but the footage is also high-quality, sound is properly mixed, and the cast and locations are set. The final content is polished and ready for use by the advertiser.

The skills required to be a successful ideator differ from that of a high-quality producer. Thus, the multi-dimensional rating for an ideator accounts for this difference and can be used to segment creative talent not only by skill, reliability, and popularity, but also whether they are best used as an ideator or a producer. In addition, the user's media quality ratings can contribute positively or negatively to his ratings as a producer.

### Example 3

### Consumer Testing

One or more video-centric surveys are distributed to an audience that is representative of a brand's target consumers. Such surveys can be used to support clients when it comes to making purchase decisions, as well as by informing creators or brands about how to potentially make their ideas or videos better in post-production, similar to market testing. The testing allows brands to quickly test numerous pieces of media to understand how effective they are at driving social engagement and movement through the purchase funnel, as well as whether specific content is actually resonating with viewers.

The methodology has been specifically designed to measure video effectiveness. The methodology ascertains how well a video performs in seven fundamental attributes: believability, shareability, enjoyment, purchase intent, annoyance, authenticity, and irony. The potential for a video's performance in online social communities is also measured to enable viewers to provide unrestricted and unbiased feedback. The scores of a specific piece of media in each attribute category compared to a benchmark can negatively or positively influence a user's multi-dimensional rating.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of generating a multi-dimensional rating for a creative producer, the method comprising:
identifying, by a computing device, a plurality of interactions between a plurality of users and an interface, wherein the plurality of users comprise one or more creative producers, one or more brands, and one or more administrators;
determining, by the computing device, whether active feedback has been received from at least one of the plurality of users based upon the plurality of interactions, wherein the active feedback comprises one or more of brand feedback, peer feedback, administrative feedback, and interface usage;
directing, by the computing device, a memory to store the active feedback;
obtaining, by the computing device, passive feedback from at least one of the plurality of users;
directing, by the computing device, the memory to store the passive feedback; and
determining, by the computing device, the multi-dimensional rating for the creative producer based upon one or more of the active feedback and the passive feedback.

2. The method of claim 1, further comprising providing, by the computing device, a creative submitted by the creative producer to the plurality of users, wherein identifying the plurality of interactions comprises identifying the plurality of interactions with respect to the creative.

3. The method of claim 1, wherein the peer feedback comprises one or more of a purchase of a creative prepared by the creative producer, an approval of a creative prepared by the creative producer, feedback of a creative prepared by the creative producer, likes of a creative prepared by the creative producer, comments to a creative prepared by the creative producer, a rating of a creative prepared by the creative producer, inclusion of a creative in a professional network, inclusion of the creative producer in a professional network, inclusion of a creative in a social network, inclusion of the creative producer in a social network, a peer-awarded medal, and a peer-awarded rating.

4. The method of claim 1, wherein the brand feedback comprises one or more of a purchase of a creative prepared by the creative producer by a brand, an approval of a creative, a brand-awarded medal, and a brand-awarded rating.

5. The method of claim 1, wherein the administrator feedback comprises one or more of an approval of a creative produced by the creative producer, an administrator-awarded medal, and an administrator-awarded rating.

6. The method of claim 1, wherein the interface usage comprises one or more of an upload of a creative, a comment, a profile setup, a profile modification, a page view, and participation in an assignment to produce a creative.

7. The method of claim 1, wherein the passive feedback comprises one or more of information generated indirectly with respect to the creative producer, community relationships, media performance, and the interface usage.

8. The method of claim 1, wherein the passive feedback comprises information generated indirectly with respect to community relationships, wherein the community relationships comprise one or more of a relationship between the creative producer and a professional network of the creative producer, a relationship between the creative producer and a social network of the creative producer, one or more multi-dimensional rating values for one or more other users, a demographic makeup of the professional network, a demographic makeup of the social network, and site activity of other users.

9. The method of claim 1, wherein the passive feedback comprises information generated indirectly with respect to media performance, wherein the media performance comprises one or more of a performance of media that the creative producer has provided to the interface in terms of paid and owned views, paid and owned conversions of the media, and meta information of the media.

10. A system for generating a multi-dimensional rating for a creative producer, the system comprising:
a storage device configured to store one or more creatives in a database that is configured to be indexed for searching;
a processor; and
a non-transitory, processor-readable storage medium in communication with the processor, wherein the non-transitory, processor-readable storage medium comprises one or more programming instructions that, when executed, cause the processor to:
identify a plurality of interactions between a plurality of users and an interface, wherein the plurality of users comprise one or more creative producers, one or more brands, and one or more administrators;
determine whether active feedback has been received from at least one of the plurality of users based upon the plurality of interactions, wherein the active feedback comprises one or more of brand feedback, peer feedback, administrative feedback, and interface usage;
direct the storage device to store the active feedback;
obtain passive feedback from at least one of the plurality of users;
direct the storage device to store the passive feedback; and
determine the multi-dimensional rating for the creative producer based upon one or more of the active feedback and the passive feedback.

11. The system of claim 10, further comprising one or more programming instructions that, when executed, cause the processor to:
provide a creative submitted by the creative producer to the plurality of users, wherein identifying the plurality of interactions comprises identifying the plurality of interactions with respect to the creative.

12. The system of claim 10, wherein the peer feedback comprises one or more of a purchase of a creative prepared by the creative producer, an approval of a creative prepared by the creative producer, feedback of a creative prepared by the creative producer, likes of a creative prepared by the creative producer, comments to a creative prepared by the creative producer, a rating of a creative prepared by the creative producer, inclusion of a creative in a professional network, inclusion of the creative producer in a professional network, inclusion of a creative in a social network, inclusion of the creative producer in a social network, a peer-awarded medal, and a peer-awarded rating.

13. The system of claim 10, wherein the brand feedback comprises one or more of a purchase of a creative prepared by the creative producer by a brand, an approval of a creative, a brand-awarded medal, and a brand-awarded rating.

14. The system of claim 10, wherein the administrator feedback comprises one or more of an approval of a creative produced by the creative producer, an administrator-awarded medal, and an administrator-awarded rating.

15. The system of claim 10, wherein the interface usage comprises one or more of an upload of a creative, a comment, a profile setup, a profile modification, a page view, and participation in an assignment to produce a creative.

16. The system of claim 10, wherein the passive feedback comprises one or more of information generated indirectly with respect to the creative producer, community relationships, media performance, and the interface usage.

17. The system of claim 1, wherein the passive feedback comprises information generated indirectly with respect to community relationships, wherein the community relationships comprise one or more of a relationship between the creative producer and a professional network of the creative producer, a relationship between the creative producer and a social network of the creative producer, one or more multi-dimensional rating values for one or more other users, a demographic makeup of the professional network, a demographic makeup of the social network, and site activity of other users.

18. The system of claim 1, wherein the passive feedback comprises information generated indirectly with respect to media performance, wherein the media performance comprises one or more of a performance of media that the creative producer has provided to the interface in terms of paid and owned views, paid and owned conversions of the media, and meta information of the media.

19. A method of selecting a creative producer for a brand, the method comprising:
receiving, by a computing device, a brand project request;
analyzing, by the computing device, the brand project request to determine one or more parameters of the brand project request;
determining, by the computing device, one or more users suited to receive the brand request based upon the one or more parameters, wherein the one or more users each has a multi-dimensional rating that corresponds to at least a portion of the one or more parameters;
providing, by the computing device, a list comprising the one or more users to the brand;
receiving, by the processor, at least a subset of the one or more users, wherein the subset corresponds to one or more users desired by the brand;
providing, by the processor, a notification to the subset;
receiving, by the processor, an affirmative response from at least one user in the subset; and
providing, by the processor, the affirmative response to the brand.

20. The method of claim 19, wherein the parameters comprise one or more of a desired skill, a reliability requirement, a media performance requirement, a primary dimension requirement, a budget, a timeframe, a location of the creative producer, and a skill set of the creative producer.
